(19) United States
(12) Patent Application Publication
(10) Pub. No.: US 2024/0027249 A1
(43) Pub. Date: Jan. 25, 2024

(54) VIBRONIC SENSOR HAVING ECCENTRIC EXCITATION

(71) Applicant: Endress+Hauser Flowtec AG, Reinach (CH)

(72) Inventors: Hao Zhu, Freising (DE); Claude Hollinger, Aesch (CH)

(21) Appl. No.: 18/245,427

(22) PCT Filed: Jun. 18, 2021
(86) PCT No.: PCT/EP2021/072743

§ 371 Date: Mar. 15, 2023

(30) Foreign Application Priority Data
Sep. 15, 2020 (DE) 10 2020 123 999.8

(51) Int. Cl. G01F 1/84

(52) U.S. Cl. CPC G01F 1/8422; G01F 1/8436; G01F 1/8472

(57) ABSTRACT

A sensor includes an oscillator having a measuring tube for a medium, an exciter array having two exciter assemblies, an inlet-side and an outlet-side sensor array, and a measuring and operating circuit for driving the exciter array and detecting the sensor arrays. A first of the exciter assemblies is secured to a measuring tube, and the measuring tube is intended to be excited to vibrate in relation to a second of the exciter assemblies. A center of gravity of the first exciter assembly lies in a measuring tube transverse plane in relation to which the measuring tube runs mirror-symmetrically. The exciter array comprises an electrodynamic exciter and a compensating mass, where the electrodynamic exciter is designed to exert an exciter force, which acts between the first and the second exciter assembly, on the measuring tube. The effective center of the exciter force is located outside the measuring tube transverse plane.

The present invention relates to a vibronic sensor for mass flow and density measurement with eccentric excitation.

The density of a medium guided in the measuring tube is determined by means of a vibronic sensor on the basis of the natural frequencies of vibration modes of the measuring tube. Ideally, the medium is incompressible, so that the medium follows the movement of the measuring tube in measuring tube vibrations. However, if the medium is compressible, e.g., due to a gas charging of the medium, the mass flow measurement and the density measurement can be flawed, because the medium begins to oscillate with respect to the measuring tube. The influence of this so-called resonator effect can be corrected by detecting the natural frequencies of two vibration modes, wherein, essentially, a sound velocity of the medium is determined for which density measurement values corresponding to the two natural frequencies for the medium result. Details on this are disclosed, for example, in DE 10 2015 122 661 A1. The first and second symmetric vibration modes, i.e., the f1 mode and the f3 mode, are usually excited for this purpose. However, in some sensors, the natural frequency of the second symmetric vibration mode f3 can be high enough that it is within the range of the resonance frequency of the medium, so that a stable excitation of the second symmetric vibration mode cannot be reliably ensured. In this case, the first antisymmetric vibration mode is an attractive alternative, because the natural frequency of this mode is lower, and thus a greater distance from the resonance frequency of the measuring tube is to be expected.

US 2003/0131669 A1 discloses a vibronic sensor having two, eccentrically-arranged exciter arrays, which are positioned symmetrically, with respect to the center of the measuring tube, at a great distance from one another. The selection of the modes to be excited is made via the frequency and the phase relationship of the exciter signals that are applied to the two exciters. Deviations in the phase relationship or unequal amplitudes of the forces result in the excitation of other, undesirable modes. This can lead to undetected measurement errors, which cannot be compensated for. In addition, two exciters, which are controlled independently of one another, are accompanied by an increased complexity in wiring and circuitry.

It is the object of the present invention to provide a vibronic sensor which enables an excitation of the first symmetric vibration mode and the first antisymmetric vibration mode without impairing the normal measuring operation, which takes place on the basis of the first symmetric vibration mode.

The object is achieved according to the invention by the vibronic measurement sensor according to independent claim 1.

The sensor according to the invention comprises:
an oscillator having at least one measuring tube for conducting the medium;
only one exciter array for exciting the oscillator to bending oscillations of the at least one measuring tube;
at least one inlet-side sensor arrangement for detecting the bending oscillations of the at least one measuring tube; and
at least one outlet-side sensor arrangement for detecting the bending oscillations of the at least one measuring tube; and
a measuring and operating circuit, which is configured to apply an exciter signal to the exciter array, and to detect sensor signals of the inlet-side and outlet-side sensor arrays, and, based upon the sensor signals, to determine a density measurement value and/or a mass flow rate measurement value,
wherein the exciter array has a first exciter assembly, which is attached to the at least one measuring tube, and a second exciter assembly, with respect to which the at least one measuring tube is to be excited to oscillate, wherein the first exciter assembly has a center of gravity which lies, up to manufacturing tolerances, within a measuring tube transverse plane running perpendicular to the at least one measuring tube, and with respect to which the at least one measuring tube runs mirror-symmetrically, wherein the exciter array comprises an electrodynamic exciter and a compensating mass, wherein the electrodynamic exciter is configured to exert an exciter force on the at least one measuring tube acting between the first and the second exciter assembly, wherein an effective center of the exciter force is located outside the measuring tube transverse plane.

In a further development of the invention, the at least one measuring tube has a free oscillation length, which extends between an inlet-side fixation of the measuring tube and an outlet-side fixation of the measuring tube, wherein the center of the exciter force is spaced apart from the measuring tube transverse plane by no less than 0.5% of the free oscillation length, in particular no more than 1% of the free oscillation length, and no more than 10% of the free oscillation length, in particular no more than 5%.

In the case of an exciter which has a coaxial arrangement of a rotationally-symmetrical magnet with a rotationally-symmetrical coil, the center of the exciter force lies on the common axis of the rotational symmetry. In other embodiments, the center of the exciter force for an electromagnetic exciter is to be determined as the center of gravity of the integral of the force density between magnet and coil.

In a further development of the invention, a main axis of inertia of the first exciter assembly runs in the measuring tube transverse plane, wherein this main axis of inertia runs in particular perpendicular to the oscillation direction of the measuring tube in the measuring tube transverse plane. This means that the eccentric arrangement of the exciter has an effect on the forces, but does not introduce any inertia-induced angular momentum into the vibrating first measuring tube.

In a further development of the invention, the first exciter assembly is fastened to the at least one measuring tube by means of a joint, wherein the measuring tube transverse plane runs through the joint. With the fastening of the exciter assembly in the measuring tube center, the same positioning and fastening methods can ultimately be used for sensors according to the invention as for sensors according to the prior art with purely symmetrical excitation. The eccentric excitation is made possible by the particular design of the assemblies of the exciter array.

According to a further development of the invention, the first exciter assembly comprises a magnet, wherein the second exciter assembly comprises a coil configured to generate an alternating magnetic field with which the magnet interacts in order to excite the vibrations of the measuring tube.

According to a further development of the invention, the first exciter assembly has a carrier body on which the magnet and the compensating mass are arranged, wherein the carrier body is formed symmetrically with respect to the measuring tube transverse plane.

According to a further development of the invention, the sensor arrays are each designed as electrodynamic sensor arrays with a coil and a magnet.

According to a further development of the invention, the oscillator further has a second measuring tube, wherein the first measuring tube and the second measuring tube run mirror-symmetrically to one another with respect to a sensor longitudinal plane, wherein the sensor longitudinal plane runs perpendicular to the measuring tube transverse plane. In this case, the free oscillation length is defined, for example, by coupling plates with which the two measuring tubes are connected on the inlet side and on the outlet side.

According to a further development of the invention, the second exciter assembly is fastened to the second measuring tube with respect to the first exciter assembly, wherein the center of gravity of the second exciter assembly is, up to manufacturing tolerances, within the measuring tube transverse plane.

According to a further development of the invention, a main axis of inertia of the second exciter assembly runs in the measuring tube transverse plane, wherein this main axis of inertia runs in particular perpendicular to the oscillation direction of the second measuring tube in the measuring tube transverse plane. This means that the eccentric arrangement of the exciter has an effect on the forces, but does not introduce any inertia-induced angular momentum into the vibrating second measuring tube.

According to a further development of the invention, the exciter signal comprises a periodic signal with the natural frequency of a symmetric vibration mode of the at least one measuring tube and/or the natural frequency of an antisymmetric vibration mode of the at least one measuring tube.

According to a further development of the invention, the measuring and operating circuit is configured to excite the first symmetric vibration mode and the first antisymmetric vibration mode, the natural frequencies of the first symmetric vibration mode and the first antisymmetric vibration mode, to determine, on the basis of the natural frequencies of the first symmetric vibration mode and the first antisymmetric vibration mode, a density measurement value or mass flow measurement value for a medium guided in the measuring tube, wherein the density measurement value or the mass flow measurement value with respect to a resonator effect is corrected based upon a gas charging of the medium.

Because the first antisymmetric vibration mode generally has a significantly lower natural frequency than the second symmetric vibration mode, the influence of the gas charging can, with the described procedure, also be determined for such gas concentrations, in which the second symmetric mode can no longer be reliably excited, due to the resonator effect.

The invention is now explained in more detail on the basis of the exemplary embodiments shown in the figures.

The following are shown:

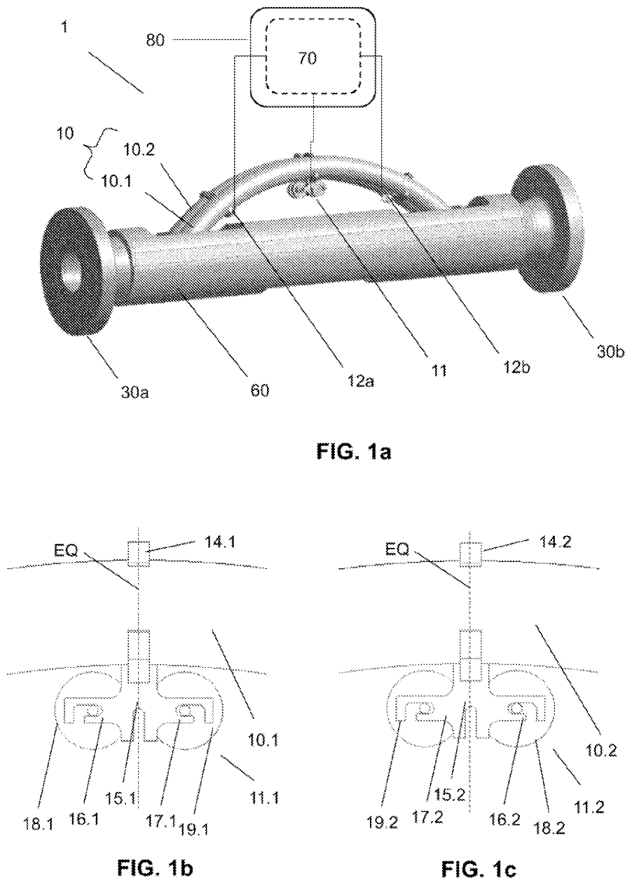

FIG. 1a: a representation of an exemplary embodiment of a sensor according to the invention;

FIG. 1b: a schematic side view of a first exciter assembly of the sensor of FIG. 1a;

FIG. 1c: a schematic side view of a second exciter assembly of the sensor of FIG. 1a;

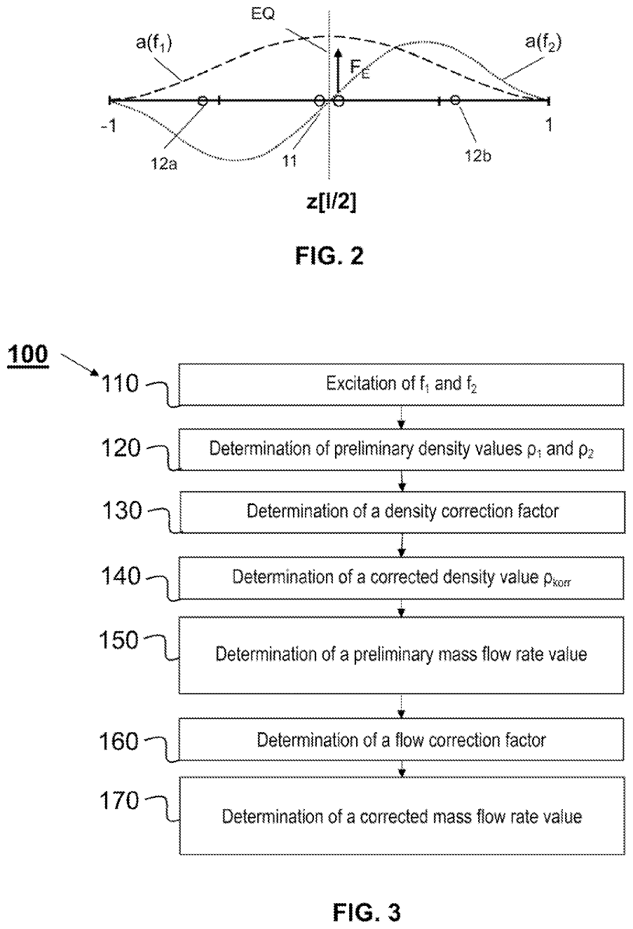

FIG. 2: a diagram of the vibration modes of a sensor;

FIG. 3: a flowchart for determining the density of a compressible medium with the sensor according to the invention;

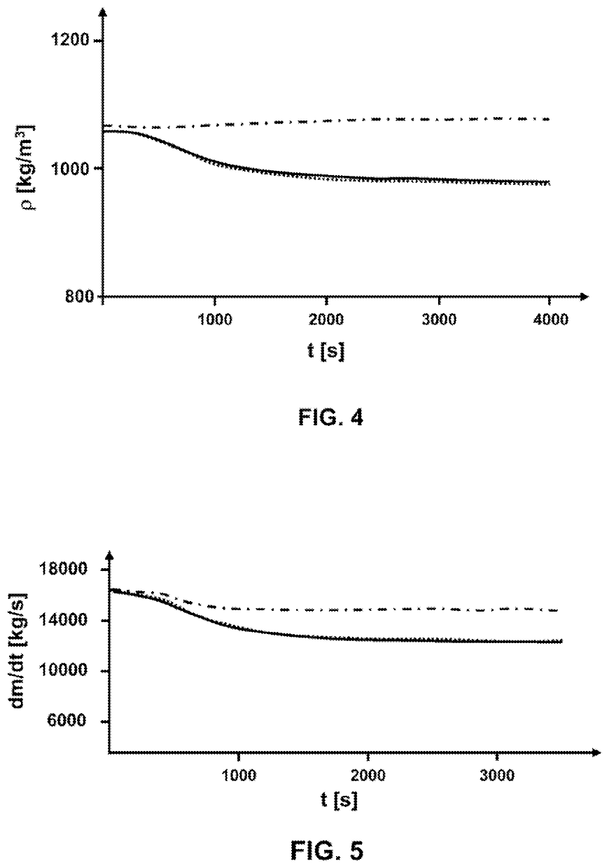

FIG. 4: measurement data for density measurement with the sensor according to the invention; and

FIG. 5: measurement data for mass flow measurement with the sensor according to the invention.

The sensor 1 shown in FIG. 1a for measuring mass flow and density comprises an oscillator 10 with two curved measuring tubes 10.1, 10.2 running substantially in parallel, and an exciter array 11 which acts between the measuring tubes 10 in order to excite them to form bending oscillations. The exciter array 11 is fastened to the measuring tubes 10.1, 10.2 in such a way that the center of an exciter force generated by it lies outside a measuring tube transverse plane which intersects the measuring tubes perpendicularly, and with respect to which each of the measuring tubes runs mirror-symmetrically. In the exemplary embodiment, the center of the exciter force in the longitudinal direction of the measuring tubes is located spaced apart from the measuring tube transverse plane by approximately 2.5% of the length L of the measuring tubes 10.1, 10.2. Upon excitation of the oscillator by means of the exciter array 11, a sufficient asymmetric exciter force component therefore acts in order also to be able to excite the first antisymmetric vibration mode, the so-called f2 mode, to create resonant vibrations if the excitation of the oscillator 10 takes place with a resonance frequency f2 of the first antisymmetric vibration mode. Furthermore, the sensor 1 has two sensor arrays 12a, 12b which are symmetric with respect to the measuring tube transverse plane, in order to detect the measuring tube vibrations as a relative movement of the measuring tubes 10.1, 10.2 that oscillate against each other. The measuring tubes 10.1, 10.2 extend between two flow dividers (not shown), which fluidically combine the measuring tubes 10.1, 10.2 and are respectively connected to a flange 30a, 30b, which serves for the installation of the sensor 1 in a pipeline. A rigid carrier tube 60 which connects the flow dividers to one another extends between said flow dividers in order to suppress vibrations of the flow dividers counter to one another in the frequency range of the bending vibration modes of the oscillator 10 counter to one another. The carrier tube 60 further carries an electronics housing 80, shown here only schematically, in which a measuring and operating circuit 70 is contained, which circuit is configured to operate the sensor.

The exciter array 11 and the sensor arrays 12a, 12b have, as usual, electrodynamic transducers, wherein, on one of the measuring tubes, in each case a magnet is arranged, and, on the other, a coil. This principle is known per se and does not need to be explained in more detail here. The special feature of the sensor according to the invention is that, in addition to the excitation of symmetric bending vibration modes, the exciter array 11 also enables an excitation of antisymmetric bending vibration modes of the oscillator, and nevertheless is balanced with respect to its mass distribution. For this purpose, the exciter array 11 comprises a first exciter assembly 11.1 on a first measuring tube 10.1, as illustrated in FIG. 1b, and a second exciter assembly 11.2, which is arranged opposite the first exciter assembly 11.1 on a second measuring tube 10.2, as FIG. 1c shows.

The first exciter assembly 11.1 shown in FIG. 1b comprises a first ring segment 14.1 which partially surrounds the first measuring tube 10.1 symmetrically with respect to the measuring tube transverse plane and is integrally joined to the first measuring tube 10.1—for example, by brazing. The first ring segment 14.1 holds an in particular planar first carrier body 15.1, which runs substantially perpendicular to the measuring tube transverse plane, and is symmetric to the measuring tube transverse plane. The first carrier body 15.1 has a slotted first exciter component carrier 16.1 and a slotted first compensating mass carrier 17.1. The first exciter component carrier 16.1 carries an exciter magnet component 18.1, which is positioned by means of a pin which engages in a slot of the first exciter component carrier 16.1 and is fixed thereto, for example, by soldering, gluing, or screwing. The first compensating mass carrier 17.1 carries a compensating mass body 19.1, which is positioned by means of a pin that engages in a slot of the first compensating mass carrier 17.1 and is fixed thereto, for example, by soldering, gluing, or screwing. The first compensating mass body 19.1 is matched to the mass of the exciter magnet component 18.1 in such a way that the common center of gravity lies in the measuring tube transverse plane. In particular, the first compensating mass body 19.1 and the exciter magnet component 18.1 have the same mass. A main axis of inertia of the first exciter assembly 11.1 runs in the measuring tube transverse plane.

The second exciter assembly 11.2 shown in FIG. 1c comprises a second ring segment 14.2 which partially surrounds the second measuring tube 10.2 symmetrically with respect to the measuring tube transverse plane and is integrally joined to the second measuring tube 10.2—for example, by brazing. The second ring segment 14.2 holds a second carrier body 15.2, which is in particular planar, runs substantially perpendicular to the measuring tube transverse plane, and is symmetrical to the measuring tube transverse plane. The second carrier body 15.2 has a slotted, second exciter component carrier 16.2 and a slotted, second compensating mass carrier 17.2. The second exciter component carrier 16.2 carries an exciter coil component 18.2, which is positioned by means of a pin that engages in a slot of the second exciter component carrier 16.2 and is fixed thereto by soldering, gluing, or screwing, for example. The exciter coil component 18.2 and the exciter magnet component 18.1 are oriented in alignment with one another in relation to the longitudinal direction of the measuring tubes. The second compensating mass carrier 17.2 carries a compensating mass body 19.1, which is positioned by means of a pin which engages in a slot of the second compensating mass carrier 17.2 and is fixed thereto, for example, by soldering, gluing, or screwing. The second compensating mass body 19.2 is thus matched to the mass of the exciter coil component 18.2 such that the common center of gravity lies within the measuring tube transverse plane. In particular, the second compensating mass body 19.2 and the exciter coil component 18.2 have the same mass. A main axis of inertia of the second exciter assembly 11.2 runs in the measuring tube transverse plane. The second ring segment 14.2 is in particular structurally identical to the first ring segment 14.1, and the second carrier body 15.2 is in particular structurally identical to the first carrier body 15.1.

The main axes of inertia of the first exciter assembly 11.1 and of the second exciter assembly 11.2 in the measuring tube transverse plane run parallel to one another, and in particular mirror-symmetrically to one another, with respect to a sensor longitudinal plane which runs between the two measuring tubes 10.1, 10.2, wherein the two measuring tubes are arranged mirror-symmetrically to one another with respect to the sensor longitudinal plane.

The exciter coil component 18.2 is configured to be supplied by the measuring and operating circuit 70 with an alternating current signal, the frequency of which corresponds to the instantaneous natural frequency of a bending vibration mode to be excited. Of course, alternating current signals of different frequencies may also be superimposed, e.g., with the instantaneous natural frequencies of the first symmetric and the first antisymmetric bending vibration mode. The resulting magnetic field alternately effects an attractive and repulsive force on the exciter magnet component 18.1, whereby the two measuring tubes 10.1, 10.2 of the oscillator are set into vibration counter to one another.

The exciter magnet component 18.1, the exciter coil component 18.2, and the two compensating mass bodies 19.1, 19.2 are preferably rotationally symmetrical, wherein the axis of rotation runs substantially in the direction of the vibrations of the measuring tubes. In particular, the exciter magnet component 18.1, the exciter coil component 18.2, and the two compensating mass bodies 19.1, 19.2 have a cylindrical symmetry, at least in sections.

The mode-dependent deflection of a measurement tube is shown schematically in FIG. 2. The curve a(f₁) here shows the bending line of a measuring tube for the first symmetric vibration mode, which is also called the drive mode or f₁ mode. The curve a(f₂) shows the bending line of the measuring tube for the first antisymmetric vibration mode, in which the measuring tube is deflected by the Coriolis forces if a mass flow flows through the measuring tube that is vibrating with the first symmetric vibration mode. The first antisymmetric vibration mode has a vibration node in the tube center at z=0 in the longitudinal direction of the measurement tube. An exciter at this position would not be able to excite a vibration of the first antisymmetric vibration mode. Therefore, the exciter array 11 is positioned in such a way that the exciter force F E acts offset with respect to the measuring tube transverse plane by approximately 2.5% of the measuring tube length, i.e., approximately 5% of half the measuring tube length between the measuring tubes. The measuring tube length here is the length of a measuring tube center line, following the curved course of a measuring tube, between the inlet-side and outlet-side flow dividers in which the measuring tubes 10 are fixed at their ends. In the offset position, the exciter can excite the first antisymmetric vibration mode if it excites an exciter force F E at the resonance frequency of the first antisymmetric vibration mode.

The positions of the sensor arrays 12a, 12b are selected symmetrically, in the longitudinal direction z, with respect to the measuring tube center of the measuring tubes, such that the deflections of the vibration sensors produce a sufficient measurement signal in the case of both vibrations in the drive mode and the first antisymmetric vibration mode.

The measuring and operating circuit is configured to excite the first symmetric vibration mode and the first antisymmetric vibration mode, to determine the natural frequencies of the first symmetric vibration mode and the first antisymmetric vibration mode, to determine, on the basis of the natural frequencies of the first symmetric vibration mode and the first antisymmetric vibration mode, a density measurement value or mass flow measurement value for a medium guided in the measuring tube, wherein the density measurement value or the mass flow measurement value with respect to a resonator effect is corrected based upon a gas charging of the medium. The influence of this so-called resonator effect can be corrected by detecting the natural frequencies of two vibration modes, wherein, essentially, a sound velocity of the medium is determined for which density measurement values corresponding to the two natural frequencies for the medium result. Details of this are disclosed, for example, in DE 10 2015 122 661 A1, wherein the first and second symmetric vibration modes are to be evaluated according to the teaching described therein. With reference to FIG. 3, the method 100 is now explained, for the implementation of which the measuring and operating circuit is configured. In a first step 110, the first symmetric and the first antisymmetric vibration mode are excited, i.e., the f1 mode and the f₂ mode. In a second step 120, a preliminary density measurement value is in each case determined based upon the natural frequencies of the excited modes ρ₁. ρ₂. In the case of incompressible media, the two density measurement values substantially correspond. If deviations are given, a correction factor is determined in the next step 130, which correction factor depends upon the sound velocity of the compressible medium. Accordingly, as disclosed in DE 10 2015 122 661 A1, first, the sound velocity is determined, which leads to the observed ratio of the preliminary density measurement values. On the basis of the sound velocity and one of the natural frequencies, a sealing error and a correction factor can then be determined, by means of which a corrected density measurement value ρₖₒᵣᵣ is 0 then determined in the next step 140.

To provide a correct mass flow rate measurement value, a preliminary mass flow rate measurement value 150 is first determined. In a next step 160, a flow correction factor is determined on the basis of the density error or density correction factor, as is also disclosed in DE 10 2015 122 661 A1. In a last step 170, a correct mass flow rate measurement value is determined, in which the preliminary mass flow rate measurement value is corrected with the correction factor.

The effect of the correction function results from the data in FIGS. 4 and 5, which show measurement results of density and mass flow measurements with the sensor according to the invention, wherein, during the measurement, the gas charging of a liquid medium flowing through the sensor was slowly increased.

The dash-dotted curve in FIG. 4 shows uncorrected density measurement values based upon the natural frequency of the first symmetric bending vibration mode, i.e., the f₁ mode; these also correspond to one of the preliminary density measurement values according to step 120 in the above method. By contrast, the solid line shows the actual profile of the density values. The dotted line shows the profile of the corrected density measurement values after step 140 based upon the first symmetric and the first antisymmetric bending vibration modes. The improvement is obvious, and the agreement with the actual density values is satisfactory.

The dash-dotted curve in FIG. 5 shows uncorrected flow rate measurement values. By contrast, the solid line shows the actual flow rate profile. The dotted line gives the profile of the corrected flow rate measurement values according to step 170 of the above method, based upon the first symmetric and the first antisymmetric bending vibration modes. Here too, the improvement is obvious, and the agreement with the actual flow rate measurement values is satisfactory.

In this respect, as the one, eccentrically-arranged exciter also proportionally brings about a deflection in the mode shape of the first antisymmetric vibration mode at the frequency of the first symmetric vibration mode, and this deflection could also be caused by flow-dependent Coriolis forces, the exciter causes a zero point error in the flow measurement, which is, however, easy to correct, because the excitation of the first symmetric vibration mode and the first antisymmetric vibration mode always takes place with the same exciter force at a constant exciter position. This zero point error can be determined and corrected by means of an intermittent flow measurement during an exciter oscillation which is subsiding, compared to a flow measurement with the exciter running.

1-12. (canceled)

13. A sensor comprising:
an oscillator having at least one measuring tube for conducting a medium;
only one exciter array for exciting the oscillator to bending oscillations of the at least one measuring tube;
at least one inlet-side sensor arrangement for detecting the bending oscillations of the at least one measuring tube; and
at least one outlet-side sensor arrangement for detecting the bending oscillations of the at least one measuring tube; and
a measuring and operating circuit, which is configured to apply an exciter signal to the exciter array, and to detect sensor signals of the inlet-side and outlet-side sensor arrays, and, based upon the sensor signals, to determine a density measurement value and/or a mass flow rate measurement value,
wherein the exciter array has a first exciter assembly, which is attached to the at least one measuring tube, and a second exciter assembly, with respect to which the at least one measuring tube is to be excited to oscillate, wherein the first exciter assembly has a center of gravity which lies in a measuring tube transverse plane up to manufacturing tolerances, which transverse plane runs perpendicular to the at least one measuring tube, and with respect to which the at least one measuring tube runs substantially mirror-symmetrically;
wherein the exciter array comprises an electrodynamic exciter and at least one compensating mass body, wherein the electrodynamic exciter is configured to exert an exciter force on the at least one measuring tube, which force acts between the first and second exciter assemblies, wherein an effective center of the exciter force is located outside the measuring tube transverse plane.

14. The sensor according to claim 13, wherein the at least one measuring tube has a free oscillation length which extends between an inlet-side fixation of the measuring tube and an outlet-side fixation of the measuring tube, wherein the center of the exciter force is spaced apart from the measuring tube transverse plane by no less than 0.5% of the free oscillation length and no more than 10% of the free oscillation length.

15. The sensor according to claim 13, wherein a main axis of inertia of the first exciter assembly runs in the measuring tube transverse plane.

16. The sensor according to claim 1, wherein the first exciter assembly is fastened to the at least one measuring tube by means of a joint, wherein the measuring tube transverse plane runs through the joint.

17. The sensor according to claim 13, wherein the first exciter assembly comprises a magnet, wherein the second exciter assembly comprises a coil configured to generate an alternating magnetic field with which the magnet interacts in order to excite the vibrations of the measuring tube.

18. The sensor according to claim 13, wherein the first exciter assembly has a carrier body on which the magnet and the compensating mass are arranged, wherein the carrier body is symmetrical with respect to the measuring tube transverse plane.

19. The sensor according to claim 13, wherein the sensor arrays are each formed as electrodynamic sensor arrays.

20. The sensor according to claim 13, wherein the oscillator further has a second measuring tube, wherein the first measuring tube and the second measuring tube run mirror-symmetrically to one another with respect to a sensor longitudinal plane, wherein the sensor longitudinal plane runs perpendicular to the measuring tube transverse plane.

21. The sensor according to claim 20, wherein the second exciter assembly is fastened to the second measuring tube relative to the first exciter assembly, wherein the center of gravity of the second exciter assembly lies, up to predetermined manufacturing tolerances, within the measuring tube transverse plane.

22. The sensor according to claim 20, wherein a main axis of inertia of the second exciter assembly runs in the measuring tube transverse plane.

23. The sensor according to claim 13, wherein the exciter signal comprises a periodic signal with the natural frequency of a symmetric vibration mode of the at least one measuring tube and/or the natural frequency of an antisymmetric vibration mode of the at least one measuring tube.

24. The sensor according to claim 13, wherein the measuring and operating circuit is configured to excite the first symmetric vibration mode and the first antisymmetric vibration mode, to determine the natural frequencies of the first symmetric vibration mode and the first antisymmetric vibration mode, to determine, on the basis of the natural frequencies of the first symmetric vibration mode and the first antisymmetric vibration mode, a density measurement value or mass flow measurement value for a medium guided in the measuring tube, wherein the density measurement value or the mass flow measurement value with respect to a resonator effect is corrected based upon a gas charging of the medium.
